(19) United States
(12) Patent Application Publication
(10) Pub. No.: US 2013/0174544 A1
(43) Pub. Date: Jul. 11, 2013

(54) Electric Supercharged Co-Power Hybrid Vehicle

(71) Applicant: Vincent Valetutti, Kerhonkson, NY (US)

(72) Inventor: Vincent Valetutti, Kerhonkson, NY (US)

(21) Appl. No.: 13/344,049

(22) Filed: Jan. 5, 2012

(51) Int. Cl. F02G 5/02

(52) U.S. Cl. 60/598; 180/65.265

(57) ABSTRACT

Systems and methods to achieve an electric supercharged co-power hybrid drive mechanism using a Rankine cycle system to reduce fossil fuel consumption are disclosed. The hybrid drive mechanism can be used by a vehicle or by stationary machine when fast changes of load are required. The drive mechanism comprises an internal combustion engine with an electric supercharger, an electric motor/generator and a Rankine cycle system using waste heat from the exhaust system and radiator of the combustion engine. The supercharger facilitates to further reducing the size of the combustion engine. The electrical supercharger is activated when higher power levels are required by the drive mechanism in order to push additional air into the internal combustion engine. The internal combustion engine, the electric motor/generator and the turbine are all on a same drive shaft

### BACKGROUND OF THE INVENTION

(1) Field of the Invention

This invention relates to hybrid vehicles. In particular, it relates to a hybrid vehicle using waste heat to drive a turbine, wherein an electric part provides peak power required directly and through the use of an electrically driven supercharger.

(2) Description of the Prior Art

There is a growing demand for electric and hybrid-electric vehicles due to increasing fuel cost and environmental concerns due to excessive consummation of fossil fuel. Efforts are directed toward developing propulsion systems for hybrid-electric vehicles. The objective of these worldwide development efforts is to increase gas mileage of vehicles.

Hybrid electric vehicles (HEVs) combine an internal combustion engine and one or more electric motors. It would be very desirable to further increase gas mileage beyond the capabilities of a sole combination of a combustion engine and one or more electric motors, e.g. by exploiting additional energy sources from waste heat and by using electric battery power more efficiently.

There are known patents or patent publications dealing with hybrid vehicles using additional energy sources.

U.S. Pat. No. 7,475,541 (Ibaraki et al.) describes a hybrid vehicle having an internal combustion engine, motor/generator, and Rankine cycle system for converting exhaust gas heat to steam to power the vehicle and reduce fuel consumption.

U.S. Pat. No. 6,725,662 (Baba et al.) discloses a waste heat recovery device using the Rankine cycle for creating steam from waste heat from an internal combustion engine and connecting an expander to a vehicle transmission.

BMW (Bavarian Motor Works, a German automobile manufacturer) is working on a combined cycle engine referred to as a turbosteamer, using a steam engine to convert waste heat energy from an internal combustion engine into supplemental vehicle power via a steam piston. See http://en.wikipedia.org/wiki/turbosteamer

U.S. Pat. No. 6,450,283 (Tagett) shows a waste heat conversion system for a motor vehicle, having a vapor engine coupled through an engageable clutch to the vehicle drive train.

### SUMMARY OF THE INVENTION

A principal object of the present invention is to reduce fossil fuel consumption of vehicles.

A further object of the invention is to reduce fossil fuel consumption of stationary engines.

A further object of the invention is to use waste heat of the internal combustion engine to drive a turbine or other devices that provide continuous power for a hybrid drive mechanism.

A further object of the invention is to reduce the size of the internal combustion engine.

A further object of the invention is to use an electrical part of the hybrid drive mechanism to provide additional power until a steam (or other suitable working fluid) turbine reaches available power.

A further object of the invention is to deploy an electrically driven supercharger for the internal combustion engine part of the drive mechanism.

In accordance with the objects of this invention an electric supercharged co-power hybrid drive mechanism using a Rankine cycle system to reduce fossil fuel consumption is disclosed. The apparatus invented firstly comprises: an internal combustion engine generating a driving force, having an electric supercharger attached, wherein the internal combustion engine comprises an exhaust system, said electric supercharger being powered by a rechargeable hybrid-type battery, and an electric motor/generator powered by the same hybrid-type battery, wherein the motor/generator is in motor mode generating a driving force via a means of mechanical transmission system to a load if required and is generating charge current for the battery during braking if possible and when required. Furthermore the apparatus comprises: said rechargeable battery, said means of mechanical transmission receiving driving forces and applying these driving forces as suitable to the mechanical load, and said Rankine system. The Rankine system itself comprises: an heat exchanger for generating a gas-phase working medium by heating a liquid-phase working medium using excessive heat of the combustion engine, a turbine, generating driving force from the gas-phase working medium by decreasing temperature and pressure of the gas-phase working medium, wherein the turbine is mechanically connected a means for mechanical transmission, which is driving a mechanical load, and a first pipe, transporting the gas-phase working medium from the heat exchanger to the turbine. Furthermore the Rankine cycle comprises a condenser, wherein the gas-phase working medium from the turbine, having decreased temperature and pressure, is condensed to become a saturated liquid with low pressure, a second pipe, transporting the gas-phase working medium from the turbine to the condenser, a bypass valve, deployed directly between the first and the second pipe and bypassing the turbine, transporting excess gas-phase working medium to the condenser if available recovered heat cannot be used by the turbine, a third pipe, transporting the saturated liquid from the condenser via a pump to the heat exchanger, and said pump, increasing the pressure of the saturated liquid from the condenser to the heat exchanger, to generate high-pressure steam.

In accordance with the objects of this invention a method to adapt an electric supercharged co-power hybrid drive mechanism using a Rankine cycle system to different driving situations has been achieved. The drive mechanism invented comprises firstly the steps of: (1) providing of a drive mechanism for a vehicle comprising an electric motor/generator, an internal combustion engine with an electric supercharger, a hybrid type battery, and a turbine converting waste heat from the combustion engine to driving power via a Rankine cycle, (2) detecting an actual driving situation comprising stationary, acceleration, deceleration, or cruising situation, and (3) in case of stationary situation, switching off the internal combustion engine, the supercharger, the turbine, and the motor/generator by using a start/stop system. Furthermore the drive mechanism comprises (4) in case of an acceleration situation, activating the motor/generator in motor mode together with the combustion engine including supercharger, activating then the turbine and decreasing the motor/generator as the turbine power increases, (5) in case of a deceleration situation, activating the motor/generator in generator mode charging the battery, have the combustion engine turning without fuel consumption, have the supercharger switched off, and having the turbine providing momentarily power from remaining steam for the motor/generator for charging the battery, (6) in case of a cruising situation, using only the combustion engine and the turbine without the motor/generator and the supercharger; and (7) returning to detection of actual driving situation in step (2).

### BRIEF DESCRIPTION OF THE DRAWINGS

In the accompanying drawings forming a material part of this description, there is shown:

FIG. 1 illustrates basic components of the system of the present invention.

FIG. 2 illustrates a flowchart of a method invented to adapt the drive mechanism invented to actual driving situations

### DESCRIPTION OF THE PREFERRED EMBODIMENTS

Systems and methods for a drive mechanism to reduce fossil fuel consumption are disclosed. Waste heat to drive a turbine provides additional power for an electric hybrid drive mechanism comprising an internal combustion engine combined with an electric supercharger is disclosed. The electric supercharger and turbine enable a reduction of the size of the internal combustion engine thereby reducing fuel consumption. This hybrid drive mechanism is preferably used to drive a vehicle but it could also be used for stationary engines, especially when fast changes of drive load are required. The hybrid drive mechanism is controlled by an electronic processing system based on various sensors deployed on the components of the drive mechanism.

The sensors and controls for this type of hybrid drive system are not shown in order to show the basic principles clearly. The basic system can be used for many different applications from motorcycles and automobiles to buses, trucks, and railroad engines as well as many other applications. All of these different applications require unique controls. To explain these controls here would require thousands of pages and be of little use since any person familiar with controls could easily design a control system for the particular vehicle or stationary engine, having variable load, and performance desired. Therefore what is described below is just the basic invention.

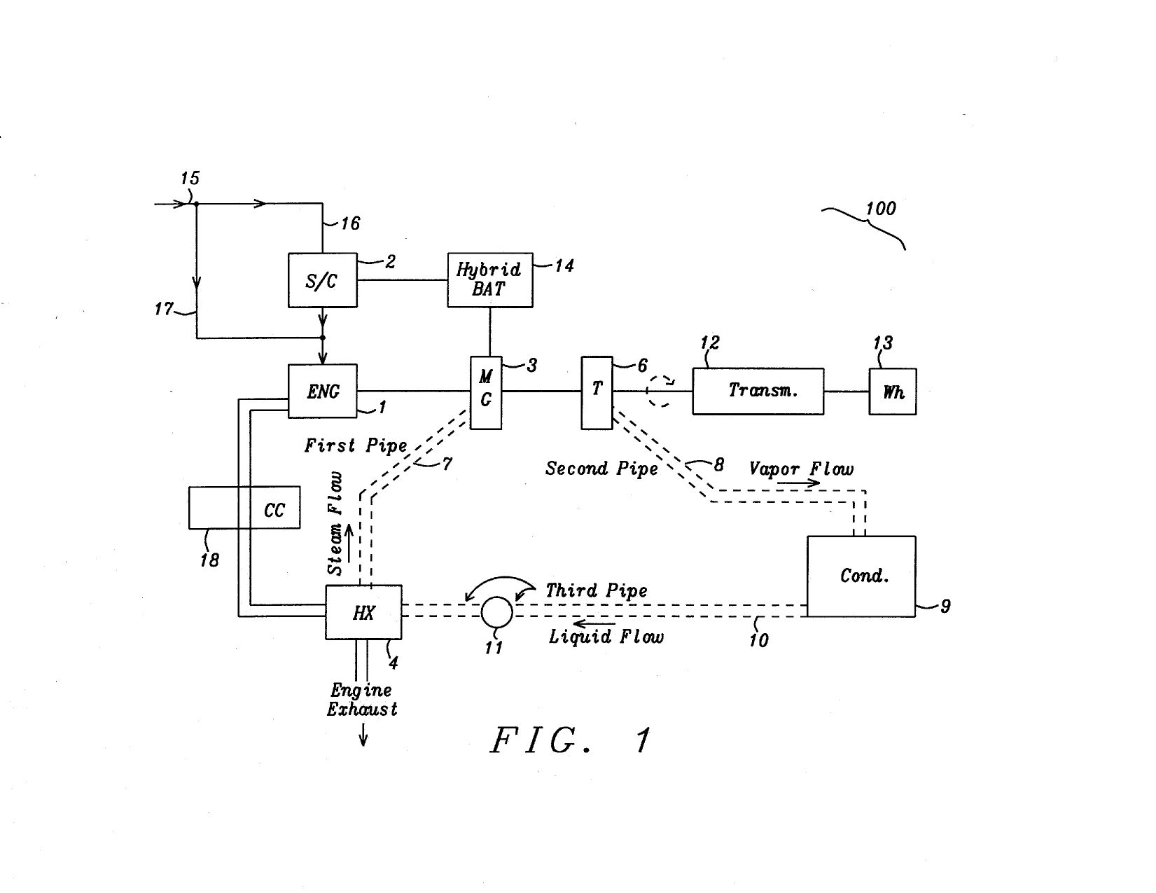

FIG. 1 illustrates basic components of the system 100 of the present invention. The system 100 comprises an internal combustion engine 1 driving a hybrid electric motor/generator 3, which is electrically connected to a rechargeable hybrid-type battery 14. Such a rechargeable hybrid-type battery has typically an improved high-current charge/discharge characteristic and operates at higher voltages (300-500 Volts) than typical car batteries. The size of the internal combustion engine 1 can be reduced by using an electric supercharger 2 receiving electric power from the battery 14. The electric supercharger 2 uses an electrically powered compressed-air system that contains a variable-speed electric motor to drive a compressor to pressurize the intake air of the internal combustion engine 1. It is designed to operate only at high power settings or for short periods of acceleration when needed. By pressurizing the air available to the engine intake system, the air becomes denser, and is matched with more fuel, producing the increased horsepower.

The airflow for the internal combustion engine comes from intake 15 and is divided into the low power air intake 17 and, in case higher power is required, the high power air intake 16, wherein the electrical supercharger 2 pressurizes all of the air into the combustion engine 1. In case the supercharger 2 is activated all air from the intake 15 is guided through the supercharger 2.

A catalytic converter 18 converts the carbon monoxide in exhaust emissions from the internal combustion engine into carbon dioxide producing additional heat. A heat exchanger 4 uses this heat of the exhaust system 5 of the combustion engine 1 to generate high-pressure steam to drive a turbine 6, which provides additional power to the hybrid drive mechanism 100. Since the temperature of the exhaust gas is usually higher after passing the catalytic converter 18, due to the chemical processes in the catalytic converter, the heat exchanger 4 is connected to the exhaust system after the catalytic converter 18. The heat exchanger 4 is a device for generating a gas-phase working medium by heating a liquid-phase working medium using the heat of the exhaust system of the combustion engine. Additionally, heat of the cooling water of the internal combustion engine radiator could be used as well to pre-heat the working fluid. This would be done with a heat exchanger located between the pump and main heat exchanger. This is not shown in the diagram for clarity purposes. Instead of water, other working fluids could be used to drive the turbine or other drive mechanism 6. The turbine 6 generates mechanical power from a gas-phase working medium by decreasing temperature and pressure of the gas-phase working medium.

Low pressure steam 8 is guided to a condenser 9, to turn the low pressure steam back to water, then low pressure water 10 is guided to a water pressure supply pump 11 supplying the heat exchanger 4 with water in order to close a Rankine cycle.

The engine 1 motor/generator 3 and turbine 6, which are all on one drive shaft without any clutch or transmission between these devices, are connected to the wheels 13 of the vehicle, or to another mechanical load, either directly or via a mechanical transmission system 12 as e.g. a standard clutch and manual transmission, continuously variable transmission or an automatic transmission. A hybrid synergy drive as used by Toyota could be used as well. The hybrid synergy drive is a planetary gear set where the various parts of the system are not on the same drive shaft. Other types of connections between the various parts of this device and the drive wheels or load are also possible.

Depending upon a present driving situation, i.e. stationary, cruising, acceleration, or deceleration, different components of the hybrid drive mechanism are activated and all are variable in nature in order to accommodate a smooth flow of power at all times.

Using a start/stop system all components of the drive mechanism may be shut off when the vehicle is stationary.

During acceleration, if higher power is required immediately, the electric motor/generator 3 in motor mode receiving electric energy from the battery 14 and the combustion engine 1, assisted, if necessary, by the supercharger 2 are activated. The turbine 6 is activated with a time lag as steam pressure increases and then the share of the electric motor/generator is decreased as the turbine power increases.

In case of deceleration the motor/generator is put into generator mode and supplies power to the hybrid battery 14. The combustion engine 1 keeps turning without fuel consumption, the supercharger 2 will be switched off and the turbine 6 could assist momentarily, using the left over steam in the system as the exhaust system cools down, the motor/generator 3 charging the hybrid battery 14. A bypass valve 19 can send excess gas-phase working medium, e.g. steam, to the condenser 9 if the available recovered heat cannot be used by the turbine.

In case of cruising the electrical motor/generator 3 and the supercharger 14 are not used and the combustion engine 1 and the turbine 6 are in use.

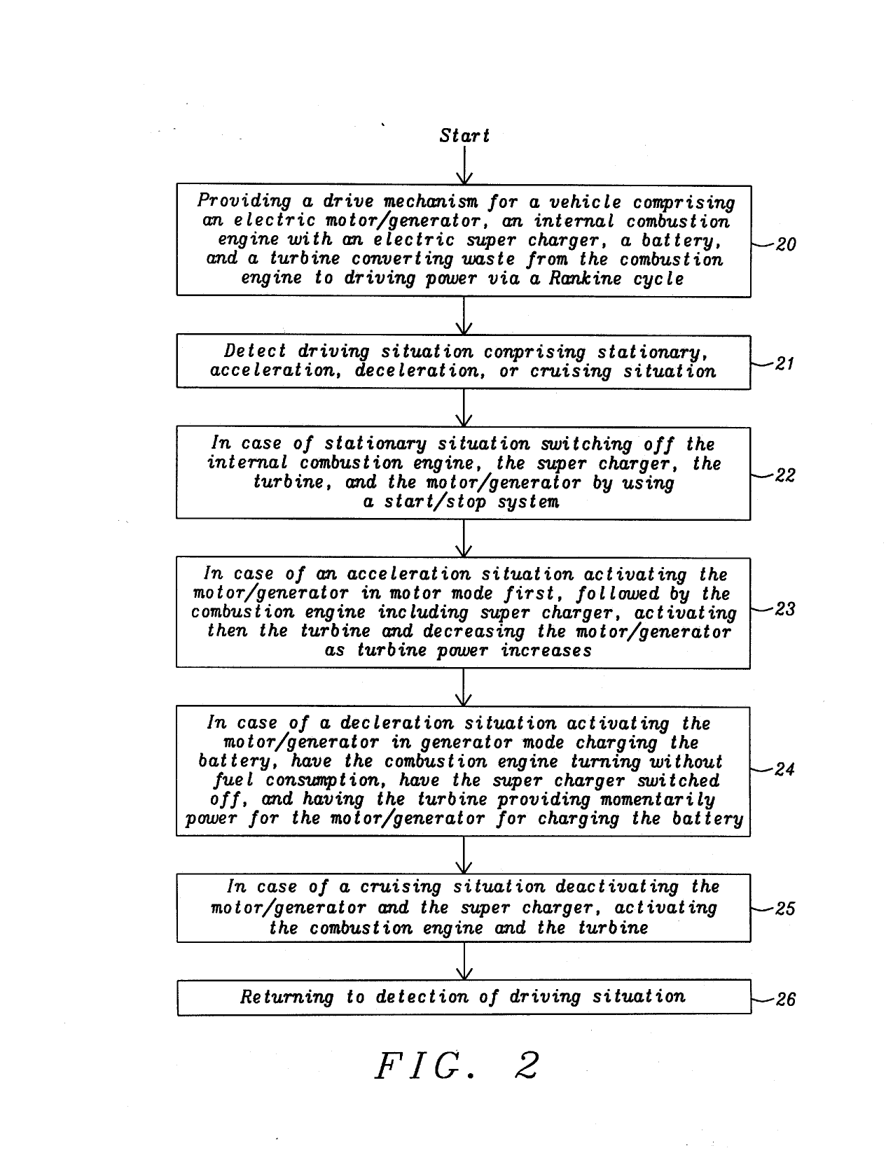

FIG. 2 illustrates a flowchart of a method invented of adapting the drive mechanism invented to actual driving situations. A first step 20 describes the provision of a drive mechanism for a vehicle comprising an electric motor/generator, an internal combustion engine with an electric supercharger, a hybrid type battery, and a turbine converting waste heat from the combustion engine to driving power via a Rankine cycle. The next step 21 describes detection of the actual driving situation comprising stationary, acceleration, deceleration, or cruising situation. Step 22 illustrates in case of stationary situation switching off the internal combustion engine, the supercharger, the turbine, and the motor/generator by using a start/stop system. Step 23 depicts in case of an acceleration situation activating the motor/generator in motor mode with the combustion engine including supercharger, then the turbine as steam pressure increases and decreasing the motor/generator as the turbine power increases. Step 24 illustrates, in case of a deceleration situation, activating the motor/generator in generator mode charging the battery, have the combustion engine turning without fuel consumption, have the supercharger switched off, and having the turbine providing momentarily power from remaining steam from exhaust heat for the motor/generator for charging the battery. Step 25 shows in case of a cruising situation without the motor/generator and the supercharger, using only the combustion engine and the turbine. Step 26 illustrates returning to detection of driving situation in step 21.

While the invention has been particularly shown and described with reference to the preferred embodiments thereof, it will be understood by those skilled in the art that various changes in form and details may be made without departing from the spirit and scope of the invention.

What is claimed is:

1. An electric supercharged co-power hybrid drive mechanism using a Rankine cycle system to reduce fossil fuel consumption, comprises:
an internal combustion engine generating a driving force, having an electric supercharger attached, wherein the internal combustion engine comprises an exhaust system;
said electric supercharger being powered by a rechargeable hybrid type battery;
an electric motor/generator wherein the motor/generator having a motor mode and a generator mode, wherein in the motor mode a driving force is generated and in generator mode charge current is generated for the hybrid type battery during deceleration and when required;
said rechargeable hybrid type battery; and
said Rankine system comprising:
an heat exchanger for generating a gas-phase working medium by heating a liquid-phase working medium using waste heat of the combustion engine;
a turbine, generating driving force from the gas-phase working medium by decreasing temperature and pressure of the gas-phase working medium;
a first pipe, transporting the gas-phase working medium from the heat exchanger to the turbine;
a condenser, wherein the gas-phase working medium from the turbine, having decreased temperature and pressure, is condensed to become a saturated liquid with low pressure;
a second pipe, transporting the gas-phase working medium from the turbine to the condenser;
a third pipe, transporting the saturated liquid from the condenser via a pump to the heat exchanger; and
said pump, increasing the pressure of the saturated liquid from the condenser to the heat exchanger, which generates high-pressure steam.

2. The apparatus of claim 1 wherein said working medium is water.

3. The apparatus of claim 1 wherein a means of mechanical transmission is receiving driving forces from a drive shaft and applying these driving forces as suitable to the mechanical load.

4. The apparatus of claim 3 wherein said mechanical transmission is a clutch and manual transmission.

5. The apparatus of claim 3 wherein said mechanical transmission is a continuously variable transmission.

6. The apparatus of claim 3 wherein said mechanical transmission is an automatic transmission.

7. The apparatus of claim 3 wherein said mechanical transmission is a planetary gear set such as Toyota's “Synergy Drive”.

8. The apparatus of claim 3 wherein said mechanical transmission is any other arrangement that sends power to the drive wheels or load.

9. The apparatus of claim 1 wherein said heat is also derived from the exhaust system of the combustion engine.

10. The apparatus of claim 1 wherein said hybrid drive mechanism is applied to drive a vehicle.

11. The apparatus of claim 1 wherein said the internal combustion engine, the electric motor/generator and the turbine are all on a same drive shaft.

12. The apparatus of claim 11 wherein no clutch is deployed between the internal combustion engine, the electric motor/generator and the turbine.

13. The apparatus of claim 1 wherein, in case the supercharger is activated, all air from an air intake is guided through the electric supercharger.

14. The apparatus of claim 1 wherein said hybrid drive mechanism is controlled by an electronic processor.

15. The apparatus of claim 1 wherein a bypass valve, deployed directly between the first and the second pipe and bypassing the turbine, is transporting excess gas-phase working medium to the condenser if available recovered heat cannot be used by the turbine.

16. A method to adapt an electric supercharged co-power hybrid drive mechanism using a Rankine cycle system to different driving situations comprising the steps of:
(1) providing of a drive mechanism for a vehicle comprising an electric motor/generator, an internal combustion engine with an electric supercharger, a hybrid type battery, and a turbine converting waste heat from the combustion engine to driving power via a Rankine cycle;
(2) detecting an actual driving situation comprising stationary, acceleration, deceleration, or cruising situation;
(3) in case of stationary situation, switching off the internal combustion engine, the supercharger, the turbine, and the motor/generator by using a start/stop system;
(4) in case of an acceleration situation, activating the motor/generator in motor mode together with the combustion engine including supercharger, activating then the turbine and decreasing the motor/generator as the turbine power increases;
(5) in case of a deceleration situation, activating the motor/generator in generator mode charging the battery, have the combustion engine turning without fuel consumption, have the supercharger switched off, and having the turbine providing momentarily power from remaining steam for the motor/generator for charging the battery;
(6) in case of a cruising situation, using only the combustion engine and the turbine without the motor/generator and the supercharger; and
(7) returning to detection of actual driving situation in step (2).

17. The method of claim 16 wherein the internal combustion engine, the electric motor/generator and the turbine are all on a same drive shaft.

18. The method of claim 16 wherein the waste heat is derived from the exhaust system of the combustion engine.

19. The method of claim 16 wherein the waste heat is also derived from a radiator of the combustion engine.

20. The method of claim 16 wherein the hybrid drive mechanism is controlled by an electronic processor.

21. The method of claim 16 wherein excess gas-phase working medium is bypassing the turbine and directly transported to the condenser if available recovered heat cannot be used by the turbine.

22. The method of claim 21 wherein said bypassing the turbine is performed by a valve deployed in parallel to the turbine.
